(19) United States
(12) Patent Application Publication
(10) Pub. No.: US 2016/0131921 A1
(43) Pub. Date: May 12, 2016

(54) LASER OSCILLATION MECHANISM

(71) Applicant: DISCO CORPORATION, Tokyo (JP)

(72) Inventor: Keiji Nomaru, Tokyo (JP)

(21) Appl. No.: 14/930,787

(22) Filed: Nov. 3, 2015

(30) Foreign Application Priority Data
Nov. 10, 2014 (JP) 2014-227862

(51) Int. Cl. G02B 27/42; H01S 3/00

(52) U.S. Cl. CPC G02B 27/4244; H01S 3/0078; G02B 27/4272

(57) ABSTRACT

A laser oscillation mechanism includes a pulse laser oscillator configured to oscillate a pulse laser beam, and a branching unit which branches the pulse laser beam oscillated by the pulse laser oscillator. The branching unit includes a diffraction optical element and a volume Bragg grating. The diffraction optical element branches the pulse laser beam oscillated by the pulse laser oscillator into a plurality of laser beams in an effective region. The volume Bragg grating refracts, from among the pulse laser beams branched by the diffraction optical element, a particular pulse laser beam to be excluded from the effective region to exclude the particular pulse laser beam.

### BACKGROUND OF THE INVENTION

1. Field of the Invention

The present invention relates to a laser oscillation mechanism incorporated in a laser processing apparatus which performs laser processing for a workpiece or a like apparatus.

2. Description of the Related Art

In a semiconductor device fabrication process, a plurality of regions are partitioned by crossing division lines arrayed on the surface of a semiconductor wafer having a substantially circular disk shape, and a device such as an IC or an LSI is formed in each of the partitioned regions. Then, by cutting the semiconductor wafer along the division lines, the regions in each of which a device is formed are divided to fabricate individual semiconductor chips.

As a method for dividing a wafer as described above, a laser processing method is attempted wherein a pulse laser beam of a wavelength having permeability to a wafer is used and irradiated with the focal point thereof adjusted to the inside of a region to be divided. In a dividing method which uses the laser processing method, a pulse laser beam of a wavelength having permeability to a wafer is irradiated with the focal point thereof adjusted to the inside of the wafer from one face side of the wafer to form a modification layer continuously along a division line inside the workpiece, whereafter external force is applied along the division line along which the strength is dropped by the formation of the modification layer to divide the wafer.

Further, as a method for dividing a wafer along a division line, a technology has been placed into practical use wherein a pulse laser beam of a wavelength having absorbability to a wafer is irradiated along a division line to perform ablation processing to form a laser processed groove and then external force is applied along the division line along which the laser processed groove which serves as a start point of breaking is formed to divide the wafer.

A laser processing apparatus which carries out the laser processing described above includes workpiece holding means for holding a workpiece, laser beam irradiation means for laser-processing the workpiece held by the workpiece holding means, and moving means for moving the workpiece holding means and the laser beam irradiation means relative to each other. A method for branching a laser beam into a plurality of laser beams to form a plurality of focal points is attempted in order to improve the processing efficiency in laser processing described above using such a laser processing apparatus as just described (for example, refer to Japanese Patent Laid-Open No. 2006-95529 or Japanese Patent Laid-Open No. 2008-290086).

### SUMMARY OF THE INVENTION

However, if a polarizing beam splitter is used in order to branch a laser beam oscillated by a laser oscillator into a plurality of laser beams to form a plurality of focal points as in the case of the laser beam irradiation means disclosed in Japanese Patent Laid-Open No. 2006-95529 or Japanese Patent Laid-Open No. 2008-290086, then the laser beam is branched into p polarized light and s polarized light. Consequently, the power density per one pulse decreases to one half and the polarization planes become different, and there is a problem that the processing quality does not become stable.

Further, if a laser beam is branched using a diffraction optical element (DOE), then the power density per one pulse is maintained and the laser beam is not branched into p polarized light and s polarized light. Therefore, the problem described above does not arise. However, since the branching angle of the DOE is small, laser beam absorption means must be disposed at the center at a point one to several meters ahead of the DOE in order to exclude zero-order light having passed through the DOE. Therefore, there is a problem that the apparatus size increases.

It is therefore an object of the present invention to provide a laser oscillation mechanism which can branch a pulse laser beam oscillated by a pulse laser oscillator into a plurality of pulse laser beams by using a diffraction optical element without upsizing the apparatus.

In accordance with an aspect of the present invention, there is provided a laser oscillation mechanism including a pulse laser oscillator configured to oscillate a pulse laser beam, and branching means for branching the pulse laser beam oscillated by the pulse laser oscillator, wherein the branching means includes a diffraction optical element configured to branch the pulse laser beam oscillated by the pulse laser oscillator into a plurality of laser beams in an effective region, and a volume Bragg grating configured to refract, from among the pulse laser beams branched by the diffraction optical element, a particular pulse laser beam to be excluded from the effective region to exclude the particular pulse laser beam.

The volume Bragg grating (VBG) refracts zero-order light to exclude the zero-order light from the effective region. Preferably, a plurality of VBGs are disposed so as to refract zero-order light and secondary light to exclude the zero-order light and the secondary light from the effective region.

Since the branching means which configures the laser oscillation mechanism according to the present invention includes a DOE which branches the pulse laser beam oscillated by the pulse laser oscillator into a plurality of laser beams in an effective region and a VBG which refracts, from among the pulse laser beams branched by the DOE, a particular pulse laser beam to be excluded from the effective region to exclude the particular pulse laser beam, the volume Bragg grating can be disposed in a neighboring relationship with the diffraction optical element. Consequently, the laser beam to be excluded from the effective region can be excluded with certainty and upsizing of the apparatus can be prevented.

Further, since the branching means which configures the laser oscillation mechanism according to the present invention branches the pulse laser beam using the diffraction optical element, the power density per one pulse is maintained. Further, since the pulse laser beam is not branched into p polarized light and s polarized light, the processing quality is stabilized.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a perspective view of a laser processing apparatus including a laser oscillation mechanism configured in accordance with the present invention;

FIG. 2 is a block diagram of laser beam irradiation means including a laser oscillation mechanism according to an embodiment of the present invention;

FIG. 3 is a block diagram of another embodiment of the laser oscillation mechanism; and

FIG. 4 is a schematic view depicting a processed state of a workpiece processed using the laser processing apparatus depicted in FIG. 1.

### DETAILED DESCRIPTION OF THE PREFERRED EMBODIMENTS

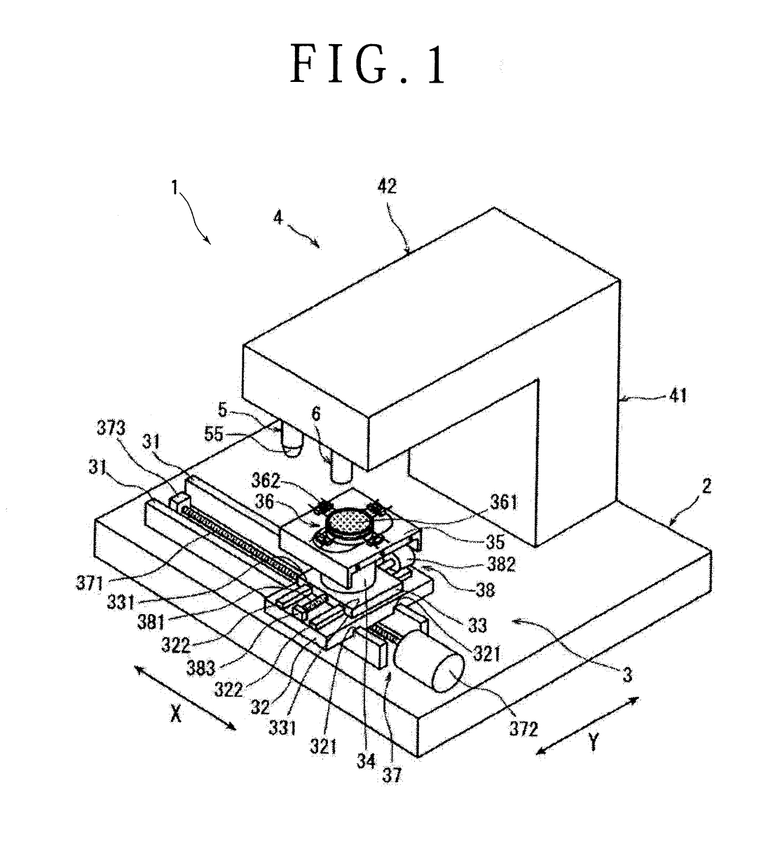

In the following, preferred embodiments of a laser oscillation mechanism configured in accordance with the present invention are described in detail with reference to the accompanying drawings. FIG. 1 depicts a perspective view of a laser processing apparatus 1 which includes a laser oscillation mechanism configured in accordance with the present invention. The laser processing apparatus 1 depicted in FIG. 1 includes a stationary base 2, a chuck table mechanism 3 disposed for movement in a processing feeding direction (X-axis direction) indicated by an arrow mark X on the stationary base 2 and configured to hold a workpiece thereon, and a laser beam irradiation unit 4 as laser beam irradiation means disposed on the stationary base 2.

The chuck table mechanism 3 includes a pair of guide rails 31 disposed in parallel to each other along the X-axis direction on the stationary base 2, a first sliding block 32 disposed for movement in the X-axis direction on the pair of guide rails 31, a second sliding block 33 disposed for movement in a Y-axis direction indicated by an arrow mark Y orthogonal to the X-axis direction on the first sliding block 32, a support table 35 supported by a cylindrical member 34 on the second sliding block 33, and a chuck table 36 as workpiece holding means. The chuck table 36 includes an absorption chuck 361 configured from a porous material, and, for example, a circular semiconductor wafer which is a workpiece is held by suction means not depicted on a holding face which is an upper face of the absorption chuck 361. The chuck table 36 configured in such a manner as just described is rotated by a pulse motor not depicted disposed in the cylindrical member 34. It is to be noted that a clump 362 for fixing an annular frame for supporting a workpiece such as a semiconductor wafer through a protective tape is disposed on the chuck table 36.

The first sliding block 32 includes a pair of guiding target grooves 321 provided on the lower face thereof for fitting with the pair of guide rails 31 and a pair of guide rails 322 formed in parallel to each other along the Y-axis direction and provided on the upper face thereof. The first sliding block 32 configured in such a manner as just described is configured for movement in the X-axis direction along the pair of guide rails 31 by fitting the guiding target grooves 321 with the pair of guide rails 31. The chuck table mechanism 3 includes X-axis direction moving means 37 for moving the first sliding block 32 in the X-axis direction along the pair of guide rails 31. The X-axis direction moving means 37 includes an external thread rod 371 disposed in parallel to and between the pair of guide rails 31 and a driving source such as a pulse motor 372 for driving the external thread rod 371 to rotate. The external thread rod 371 is supported at one end thereof for rotation on a bearing block 373 fixed to the stationary base 2 and transmission-coupled at the other end thereof to an output power shaft of the pulse motor 372. It is to be noted that the external thread rod 371 is screwed into a penetrating internal thread hole formed on an internal thread block not depicted provided in a projecting manner on the lower face of a central portion of the first sliding block 32. Accordingly, by driving the external thread rod 371 for forward rotation and reverse rotation by the pulse motor 372, the first sliding block 32 is moved in the X-axis direction along the guide rails 31.

The second sliding block 33 includes a pair of guiding target grooves 331 provided on the lower face thereof for fitting with the pair of guide rails 322 provided on the upper face of the first sliding block 32, and is configured for movement in the Y-axis direction by fitting the guiding target grooves 331 with the pair of guide rails 322. The chuck table mechanism 3 includes Y-axis direction moving means 38 for moving the second sliding block 33 in the Y-axis direction along the pair of guide rails 322 provided on the first sliding block 32. The Y-axis direction moving means 38 includes an external thread rod 381 disposed in parallel to and between the pair of guide rails 322 and a driving source such as a pulse motor 382 for driving the external thread rod 381 to rotate. The external thread rod 381 is supported at one end thereof for rotation on a bearing block 383 fixed to the upper face of the first sliding block 32 and transmission-coupled at the other end thereof to an output power shaft of the pulse motor 382. It is to be noted that the external thread rod 381 is screwed in a penetrating internal thread hole formed on an internal thread block not depicted provided in a projecting manner on the lower face of a central portion of the second sliding block 33. Accordingly, by driving the external thread rod 381 for forward rotation and reverse rotation by the pulse motor 382, the second sliding block 33 is moved in the Y-axis direction along the guide rails 322.

The laser beam irradiation unit 4 includes a support member 41 disposed on the stationary base 2, a casing 42 supported by the support member 41 and extending substantially in a horizontal direction, laser beam irradiation means 5 disposed on the casing 42, and image pickup means 6 disposed at a front end portion of the casing 42 for detecting a processing region for which laser processing is to be performed. It is to be noted that the image pickup means 6 includes illumination means for illuminating a workpiece, an optical system for capturing a region illuminated by the illumination means, an image pickup device (CCD) for picking up an image captured by the optical system, and so forth.

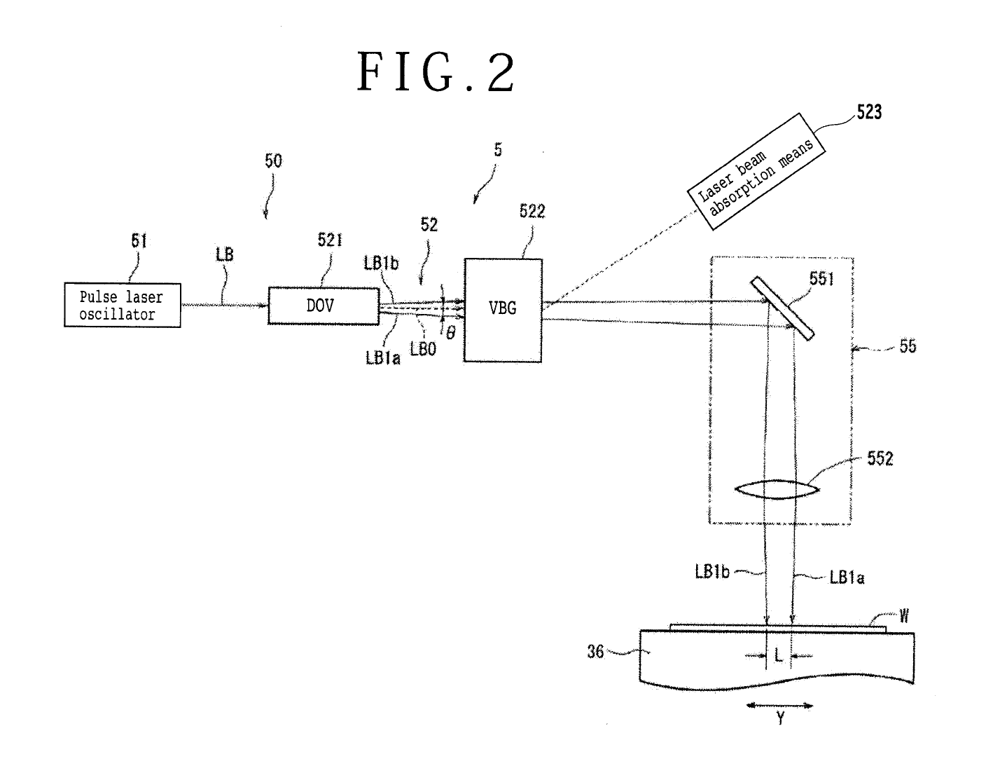

The laser beam irradiation means 5 described above is described with reference to FIG. 2. The laser beam irradiation means 5 includes a laser oscillation mechanism 50 and a condenser 55. The laser oscillation mechanism 50 is configured from a pulse laser oscillator 51 for oscillating a pulse laser beam, and branching means 52 for branching the pulse laser beam oscillated by the pulse laser oscillator 51. In the embodiment depicted, the pulse laser oscillator 51 oscillates a pulse laser beam LB of a wavelength (for example, 355 nm) having absorbability to a workpiece formed, for example, from a silicon wafer.

The branching means 52 which configures the laser beam irradiation means 5 is configured from a DOE 521 which branches the pulse laser beam LB oscillated by the pulse laser oscillator 51 into a plurality of laser beams in an effective region, and a VBG 522 which refracts a pulse laser beam to be excluded from among the pulse laser beams branched by the DOE 521 from the effective region to exclude the pulse laser beam. The DOE 521 branches the pulse laser beam LB into zero-order light LB0 on the optical axis and primary light LB1a and primary light LB1b branched at angles equal to each other with respect to the zero-order light LB0. It is to be noted that the branching angle (θ) between the primary light LB1a and the primary light LB1b is 0.1 to 0.2 degrees.

The VBG 522 which configures the branching means 52 refracts, in the present embodiment, the zero-order light LB0 from among the zero-order light LB0, primary light LB1a and primary light LB1b branched by the DOE 521 toward laser beam absorption means 523 disposed at a position displaced from the effective region as indicated by a broken line. Then, the VBG 522 introduces the primary light LB1a and the primary light LB1b to the condenser 55. Since the zero-order light LB0 to be excluded is refracted toward the laser beam absorption means 523 disposed at a position displaced from the effective region by the VBG 522, the VBG 522 can be disposed in a neighboring relationship with the DOE 521. Therefore, upsizing of the apparatus can be prevented.

The condenser 55 is configured from a direction conversion mirror 551 for converting the direction of the primary light LB1a and the primary light LB1b introduced thereto by the VBG 522 to a downward direction, and a condensing lens 552 configured to converge the primary light LB1a and the primary light LB1b, whose direction has been converted by the direction conversion mirror 551, to irradiate them upon a workpiece W held on the chuck table 36. The primary light LB1a and the primary light LB1b converged by the condensing lens 552 are converged to positions spaced by a predetermined distance (L) in the Y-axis direction as depicted in FIG. 2.

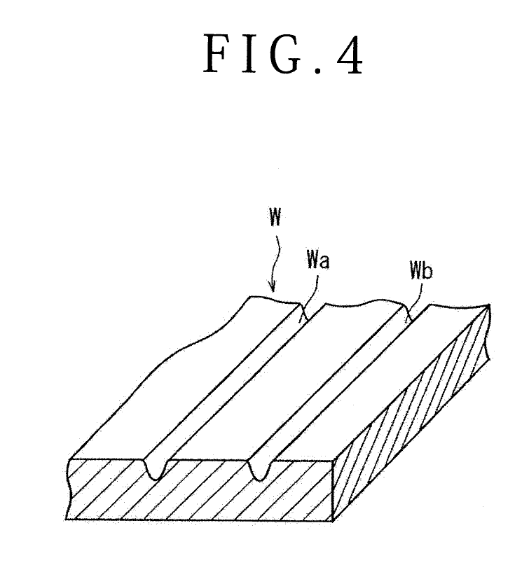

By irradiating the primary light LB1a and the primary light LB1b converged by the condensing lens 552 at positions on the workpiece W spaced by the predetermined distance (L) from each other in the Y-axis direction as described above and processing-feeding the chuck table 36 at a predetermined processing speed in the X-axis direction in FIG. 1, two laser processed grooves Wa and Wb are formed on the workpiece W as depicted in FIG. 4. It is to be noted that, since the branching means 52 of the laser oscillation mechanism 50 in the present embodiment branches a pulse laser beam using the DOE 521, the power density per one pulse is maintained, and since the laser beam is not branched into p polarized light and s polarized light, the processing quality is stabilized.

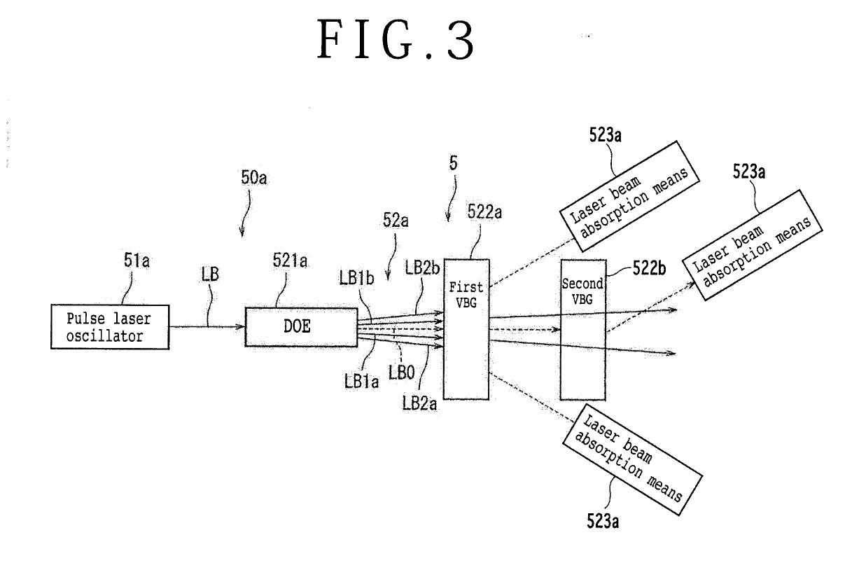

Now, another embodiment of the laser oscillation mechanism according to the present invention is described with reference to FIG. 3. A laser oscillation mechanism 50a depicted in FIG. 3 is configured from a pulse laser oscillator 51a which oscillates a pulse laser beam, and branching means 52a which branches the pulse laser beam oscillated by the pulse laser oscillator 51a. The pulse laser oscillator 51a may be same as the pulse laser oscillator 51 described hereinabove with reference to FIG. 2.

The branching means 52a which configures the laser beam irradiation means 5 is configured from a DOE 521a which branches a pulse laser beam LB oscillated by the pulse laser oscillator 51a into a plurality of laser beams in an effective region, and a first VBG 522a and a second VBG 522b which refract pulse laser beams to be excluded from among the pulse laser beams branched by the DOE 521a from within the effective region to exclude the pulse laser beams. The DOE 521a branches the pulse laser beam LB into zero-order light LB0 on the optical axis, primary light LB1a and primary light LB1b, and secondary light LB2a and secondary light LB2b as depicted in FIG. 3.

The first VBG 522a which configures the branching means 52a refracts, in the present embodiment, the secondary light LB2a and the secondary light LB2b from among the zero-order light LB0, primary light LB1a and primary light LB1b, and secondary light LB2a and secondary light LB2b branched by the DOE 521a toward laser beam absorption means 523a disposed at positions displaced from the effective region as indicated by alternate long and short dashes lines. Then, the first VBG 522a introduces the zero-order light LB0 and the primary light LB1a and primary light LB1b to the second VBG 522b.

The second VBG 522b which configures the branching means 52a refracts, in the present embodiment, the zero-order light LB0 from among the zero-order light LB0, primary light LB1a and primary light LB1b branched by the first VBG 522a toward laser beam absorption means 523a disposed at a position displaced from the effective region as indicated by a broken line. Then, the second VBG 522b introduces the primary light LB1a and the primary light LB1b to the condenser 55 similarly to the laser beam irradiation means 5 described hereinabove with reference to FIG. 2.

As described above, since the secondary light LB2a and the secondary light LB2b to be excluded by the first VBG 522a and the zero-order light LB0 to be excluded by the second VBG 522b are refracted toward the laser beam absorption means 523a disposed at the positions displaced from the effective region, the first VBG 522a and the second VBG 522b can be disposed in a neighboring relationship with the DOE 521a. Consequently, upsizing of the apparatus can be prevented.

Although the present invention has been described in connection with the embodiments depicted in the drawings, the present invention is not limited to the embodiments but can be modified in various manners in accordance with the subject matter of the present invention. For example, in the embodiments described hereinabove, an example is described wherein the laser oscillation mechanism according to the present invention is mounted on the laser processing apparatus and irradiates a pulse laser beam of a wavelength having absorbability to a wafer to form two laser processed grooves. However, two modification layers can be formed in the inside of a workpiece by irradiating a pulse laser beam of a wavelength having permeability to a wafer with a focal point thereof positioned in the inside of the workpiece.

Further, the laser oscillation mechanism according to the present invention can be applied also to laser equipment other than a laser processing apparatus.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A laser oscillation mechanism comprising:
a pulse laser oscillator configured to oscillate a pulse laser beam; and
branching means for branching the pulse laser beam oscillated by the pulse laser oscillator, wherein
the branching means includes
a diffraction optical element configured to branch the pulse laser beam oscillated by the pulse laser oscillator into a plurality of laser beams in an effective region, and
a volume Bragg grating configured to refract, from among the pulse laser beams branched by the diffraction optical element, a particular pulse laser beam to be excluded from the effective region to exclude the particular pulse laser beam.

2. The laser oscillation mechanism according to claim 1, wherein the volume Bragg grating refracts zero-order light to exclude the zero-order light from the effective region.

3. The laser oscillation mechanism according to claim 1, wherein the volume Bragg grating includes a first volume Bragg grating and a second volume Bragg grating, and the first volume Bragg grating refracts secondary light to exclude the secondary light from the effective region while the second volume Bragg grating refracts zero-order light to exclude the zero-order light from the effective region.
